(19) United States
(12) Patent Application Publication
(10) Pub. No.: US 2010/0180855 A1
(43) Pub. Date: Jul. 22, 2010

(54) FILTER MOUNT FOR AN ENGINE

(76) Inventor: WESLEY RICHARD ALFORD, Milwaukie, OR (US)

Correspondence Address: WESLEY RICHARD ALFORD, 2604 S.E. LAUREL ST., MILWAUKIE, OR, 97267, US

(21) Appl. No.: 12/605,497

(22) Filed: Oct. 26, 2009

Related U.S. Application Data
(60) Provisional application No. 61/146,377, filed on Jan. 22, 2009.

(51) Int. Cl. F02M 35/02; B01D 35/02

(52) U.S. Cl. 123/198 E; 210/236

(57) ABSTRACT

A filter mount for engine includes: a base having a bottom surface; a filter adapter adapted to engage with the filter; a mount for the filter adapter, aligned perpendicular to the bottom surface of the base; and protrusions on the base to guide the movement of the mount so that the mount travels generally perpendicular to the bottom of the base.

### RELATED APPLICATIONS

The present application claims benefit of priority from U.S. Provisional Application No. 61/146,377, filed Jan. 22, 2009, which is incorporated herein by reference in its entirety.

### BACKGROUND OF THE INVENTION

The present invention generally relates to engines, and more specifically, to a filter mount for an engine.

The Cummins(TM) 6.7 or 5.9 diesel engine has a given internal configuration for mounting its oil filter. Other trucks, such as the Dodge(R) Ram pickup truck, have a different configuration to mount filters. Yet other by-pass filters have other configurations that do not easily accommodate the Cummins(TM) engine.

As can be seen, there is a need for a filter mount for engines to adapt a filter to the engine.

### SUMMARY OF THE INVENTION

In one aspect of the present invention, a device for a mounting a filter includes: a base having a bottom surface; a filter adapter adapted to engage with the filter; a mount for the filter adapter, aligned perpendicular to the bottom surface of the base; and protrusions on the base to guide the movement of the mount so that the mount travels generally perpendicular to the bottom of the base.

In another aspect of the present invention, a method for a mounting a filter includes: providing a mount having a base, a filter adapter perpendicular to the base, and a filter adapter to retain with the filter; retaining the filter with the filter adapter; and guiding the mount so that the mount travels generally perpendicular to the bottom of the base.

These and other features, aspects and advantages of the present invention will become better understood with reference to the following drawings, description and claims.

### BRIEF DESCRIPTION OF THE DRAWINGS

FIG. 1A is a side view of an embodiment of the present invention;

FIG. 1B is a top view of an embodiment of the present invention;

FIG. 1C is a front view of an embodiment of the present invention; and

FIG. 2 is an exploded view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a filter mount for engine.

According to the embodiments described herein, a filter mount for engine can be produced. That is, the filter mount comprises a mount for attaching to an engine, and a mount for attaching a bypass filter assembly.

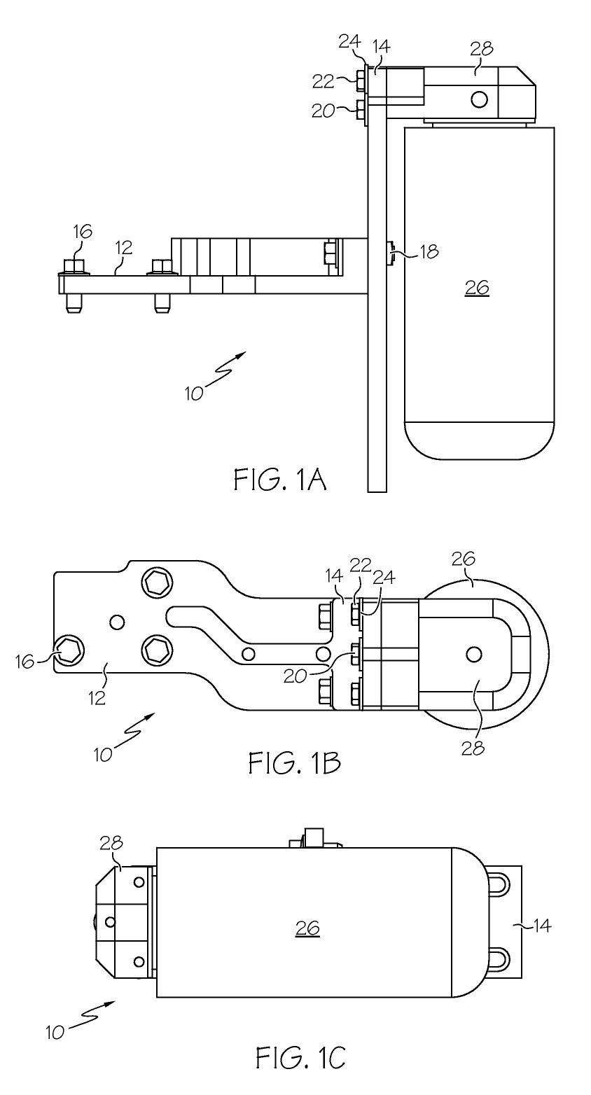

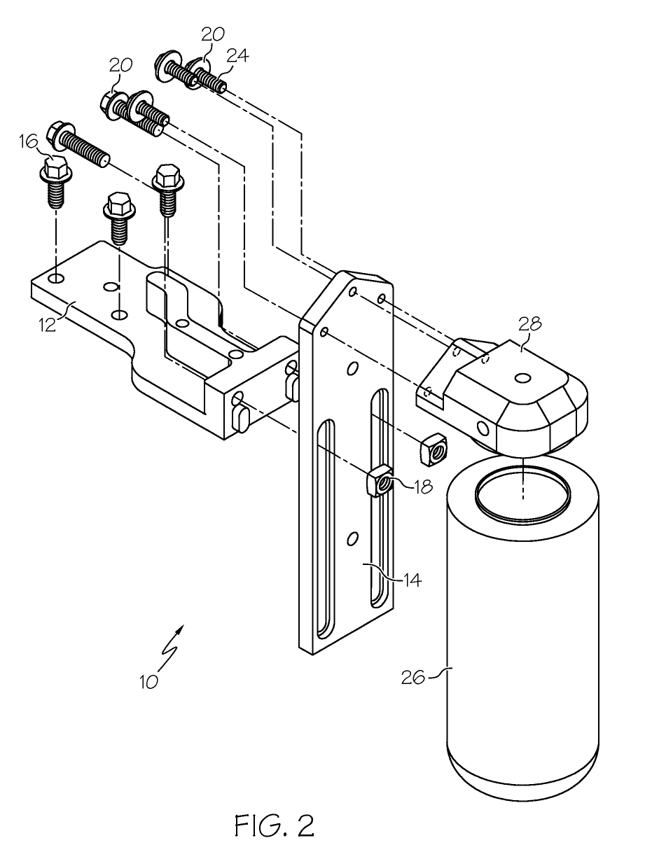

As illustrated in the embodiments of FIGS. 1A, 1B, 1C, and 2, a filter mount can include the following components: base 12, vertical mount 14, flange bolt 16, square nut 40, flange bolt 50, bolt 22, washer 24, filter 26 and filter adaptor 28.

An embodiment of the base 12 is a device configured to mount to the Cummins(TM) 6.7 or 5.9 diesel engine that is configured to be installed into a Dodge(R) Ram pickup truck. It can be installed using the three factory tap holes in the intake manifold. It can also provide a mounting surface and guiding surface for the vertical mount 14. There are protrusions machined on the base 12 to guide the movement of the vertical mount 14, and it allows the vertical mount 14 only to travel in a perpendicular direction from the bottom of the base 12. This is also perpendicular from the ground. The base 12 can be machined or cast from any ferrous or nonferrous material. The base 12 can also position the vertical mount 14, adaptor 28 and filter 26 in an open space of the engine compartment where they can function without interfering with any engine components.

An embodiment of a vertical mount 14 may be a device configured to mount to the base 12 and provide a mounting surface for filter adaptor 28. The vertical mount 14 can have guiding surfaces machined into it that mate with the base 12 guiding protrusions and control the direction of movement of the vertical mount 14. The vertical mount 14 can be machined or cast from any ferrous or nonferrous material.

In an embodiment, the flange bolt 16 (for example, 10 mm), square nut 40 (for example, ⅜ inch), flange bolt 50 (for example ⅜ inch), bolt 22 (for example, 5/16 inch), washer 24 (for example 7 and 5/16 inches) can be standard mounting hardware for this assembly. Filter 26 can be a by-pass filter that can be any commercially produce by-pass filter.

The base 12 is bolted to the engine utilizing the three factory tap holes in the front of the intake manifold. The face of the base 12 has two oval protrusions machined on its face, which mate with the two counter bored slots machined into the vertical mount 14. Two flange bolts 20 are inserted through the base from the engine side. The vertical mount 14 can be positioned on the face of the base 12 with the protrusions on the base 12 inserted in the slots of the vertical mount 14 and the counter bores side of the slot facing away from the base 12. The flange bolts 20 also pass through the vertical mount 14. The square nuts 18 can be inserted into the counter bore of the slots on the vertical mount 14 and aligned with the two flange bolt 50, which are tightened to hold the vertical mount 14. The filter adaptor 28 bolts to the mounting holes machined into the top of the vertical mount 20. The filter 26 can screw on the adaptor 28.

When the filter 26 needs to be changed, the two flange bolts 20 are loosened just enough that the vertical slide 20 can be moved to its upper position. One of the flange bolts 20 can be tightened just enough to hold the vertical mount 14 from sliding down. Then filter 26 can be unscrewed from the adaptor 28. The filter 26 can be removed without tipping the filter or interfering with any components in the engine compartment. This allows no spilling of oil during removal or installing of the filter 26. Now the new filter can be screwed back on to the adaptor 28. After the filter is installed, the flange bolts 20 are loosened and the vertical mount 14 moved down to its lower position. Then the flange bolts 20 are tightened to hold the vertical mount in place. The vertical mount 20 must be in its lower position or it will not clear the hood.

To use an embodiment, a person would place this filter mount to his Cummins(TM) 5.9 or 6.7 diesel engine and then mount a by-pass filter system to the invention. This would allow him to mount the by-pass filter system in a safe, convenient and secure position inside the engine compartment. When the system needs to be changed then the user can remove the old filter and install a new filter without having to tip the filter and spilling oil. This is accomplished with the vertical movement of the invention.

It should be understood, of course, that the foregoing relates to exemplary embodiments of the invention and that modifications may be made without departing from the spirit and scope of the invention as set forth in the following claims.

We claim:

1. A device for a mounting a filter, comprising:
a base having a bottom surface;
a filter adapter adapted to engage with the filter;
a mount for the filter adapter, aligned perpendicular to the bottom surface of the base; and
protrusions on the base to guide the movement of the mount so that the mount travels generally perpendicular to the bottom of the base.

2. The device of claim 1, wherein the device is an intake manifold with a plurality of tap holes, the mount adapted to engage with the tap holes.

3. The device of claim 1, wherein the device is adapted to mount the filter with an intake manifold for a first type of automobile having a plurality of tap holes, the mount adapted to engage with the tap holes, and the filter is for a second, different type of automobile.

4. The device of claim 1, wherein the surface of the base is horizontal and the mount is vertically moveable so that the filter may travel vertically, thereby allowing the filter to be removed without tipping the filter.

5. The device of claim 1, wherein the device is adapted to mount the filter with an intake manifold having three factory tap holes.

6. The device of claim 1, wherein the device is adapted to mount the filter with a Cummins 6.7 or 5.9 diesel engine.

7. The device of claim 1, wherein the protrusions on the base are bolts and nuts, the mount has slots adapted to engage with the bolts and nuts, and the bolts and nuts align the slides so as to guide the mount to move perpendicular to the bottom surface of the base.

8. The device of claim 7, wherein the nuts are flange nuts.

9. A method for a mounting a filter, comprising:
providing a mount having a base, a filter adapter perpendicular to the base, and a filter adapter to retain with the filter;
retaining the filter with the filter adapter; and
guiding the mount so that the mount travels generally perpendicular to the bottom of the base.

10. The method of claim 7, further comprising:
providing a filter for a first type of an automobile; and
utilizing the mount to mount the filter on a second type of an automobile.
